(19) United States
(12) Patent Application Publication
(10) Pub. No.: US 2022/0143487 A1
(43) Pub. Date: May 12, 2022

(54) Mr. Manager

(71) Applicant: John A. Mercurio, Deerfield Beach, FL (US)

(72) Inventor: John A. Mercurio, Deerfield Beach, FL (US)

(21) Appl. No.: 16/974,194

(22) Filed: Nov. 10, 2020

(51) Int. Cl. A63F 1/04; A63F 3/00

(52) U.S. Cl. CPC A63F 1/04; A63F 2003/00034; A63F 2001/0441; A63F 3/00031

(57) ABSTRACT

Baseball coachs spend most of their time teaching children how to hit, throw and run the bases. Many of them do not have the time to teach the stragedies of the game.

MR. MANAGER is a card game that allows coach and parents to teach young players the difference between a safety squeeze and a suicide squeeze. Most little leaguers do not fully understand what a balk is or the difference between a wild pitch and a passed ball or how to execute the hit and run play.

MR. MANAGER puts players in the middle of the game and makes them think about the best way of winning a game. It makes them feel like they are actually the manager.

### BACKGROUND OF THE INVENTION

A patent search has been conducted and it has been found that four others have a game that used cards similar to mine.

U.S. Pat. No. 5,762,337 by Poison is a board game which uses 3 decks. One deck is for offence, one for defense and a third has balls and strike. My game uses none of these methods.

U.S. Pat. No. 5,145,173 by Crowder plays using dice, major league playing cards and has a team A and B. A regular deck of cards are used with suits of diamonds, clubs, spades and hearts. My game uses none of these methods.

U.S. Pat. No. 3,957,269 by Bouchard uses two decks with suits of diamonds, hearts, clubs and spades. You must make 3 outs to end an inning, has 5 offensive positions and 6 defensive positions. They also use wild cards and trump cards. My game uses none of these methods.

U.S. Pat. No. 5,522,590 by Moran uses box scores and score sheets and managers fill out line up cards. My game uses none of these methods.

### BRIEF DESCRIPTION OF THE DRAWINGS

The preferred embodiment of the claimed subject matter will hereinafter be described in conjunction with the appended drawings provided to illustrate and not to limit the scope of the claimed subject matter, where like designations denote like elements, and in which:

FIG. 1 is a view of a card indicating a single moving a runner from first to third only;

FIG. 2 is a view of a card indicating a hit and run single which advances all runners one base;

FIG. 3 is a view of a card indicating a bunt single which advances all runners one base;

FIG. 4 is a view of a card indicating a single which scores a runner from second base;

FIG. 5 is a view of a card indicating a single which scores a runner from second;

FIG. 6 is a view of a card indicating a single which scores a runner from second with batter going to second;

FIG. 7 is a view of a card indicating a double which advances all runners two bases;

FIG. 8 is a view of a card indicating a double which advances all runners two bases;

FIG. 9 is a view of a card indicating a double which advances all runners two bases;

FIG. 10 is a view of a card indicating a double which advances all runners two bases;

FIG. 11 is a view of a card indicating a triple which advances all runners three bases;

FIG. 12 is a view of a card indicating a triple which advances all runners three bases;

FIG. 13 is a view of a card indicating a triple which advances all runners three bases;

FIG. 14 is a view of a card indicating a home run which advances all runners four bases;

FIG. 15 is a view of a card indicating a home run which advances all runners four bases;

FIG. 16 is a view of a card indicating a home run which advances all runners four bases;

FIG. 17 is a view of a card indicating a home run which advances all runners four bases;

FIG. 18 is a view of a card indicating a home run which advances all runners four bases;

FIG. 19 is a view of a card indicating a home run which advances all runners four bases;

FIG. 20 is a view of a card indicating a pinch hit home run which advances all runners four bases;

FIG. 21 is a view of a card indicating a fly out which advance all runners one base;

FIG. 22 is a view of a card indicating a suicide squeeze which scores a runner from third batter reaches first base;

FIG. 23 is a view of a card indicating a sacrifice fly which scores a runner from third base;

FIG. 24 is a view of a card indicating a strikeout: no runners advance;

FIG. 25 is a view of a card indicating an intentional walk which places a runner on first base;

FIG. 26 is a view of a card indicating an error which advances all runners one base;

FIG. 27 is a view of a card indicating a force out runner on first is out at second base;

FIG. 28 is a view of a card indicating a fly out with no runners advancing;

FIG. 29 is a view of a card indicating a double steal, two runners advance, batter plays another card;

FIG. 30 is a view of a card indicating a triple play; two runners and batter are out;

FIG. 31 is a view of a card indicating a double play; two runners are out or a runner and batter are out;

FIG. 32 is a view of a card indicating a runner out in a run down, batter plays another card;

FIG. 33 is a view of a card indicating a wild pitch, all runners advance one base, batter plays another card;

FIG. 34 is a view of a card indicating a runner picked off any base:

batter plays another card;

FIG. 35 is a view of a card indicating a safety squeeze with runner scoring and batter out;

FIG. 36 is a view of a card indicating a sacrifice fly which scores runner from third base;

FIG. 37 is a view of a card indicating a double play with runner on first and batter out;

FIG. 38 is a view of a card indicating a passed ball all runners advance one base; batter plays another card;

FIG. 39 is a view of a card indicating a runner out at the plate batter reaches first base;

FIG. 40 is a view of a card indicating sacrifice bunt all runners advance one base batter is out;

FIG. 41 is a view of a card indicating balk; all runners advance one base batter plays another card;

FIG. 42 is a view of a card indicating a wild pitch, all runners advance one base, batter plays another card;

FIG. 43 is a view of a card indicating a passed ball all runners advance one base; batter plays another card;

FIG. 44 is a view of a card indicating a stolen base runner on first goes to second and batter plays another card;

FIG. 45 is a view of a card indicating first base;

FIG. 46 is a view of a card indicating second base;

FIG. 47 is a view of a card indicating third base;

FIG. 48 is a view of a card indicating home plate;

FIG. 49 is a view of a card indicating an error all runners advance one base;

FIG. 50 is a view of a card indicating a walk; batter goes to first and runners advance if forced;

FIG. 51 is a view of a card indicating ground out with no advances;

FIG. 52 is a view of a card indicating sacrifice fly which scores runner from third base;

FIG. 53 is a view of a card indicating sacrifice fly which scores runner from third base;

FIG. 54 is a view of a card indicating a hit batter; runners advance if forced;

FIG. 55 is a view of a card indicating a triple play two runners and batter are out;

FIG. 56 is a view of a card indicating a triple play; two runners and batter are out;

FIG. 57 is an exemplary card from the card deck;

FIG. 58 is an exemplary card from the card deck; and

FIG. 59 is an exemplary card from the card deck.

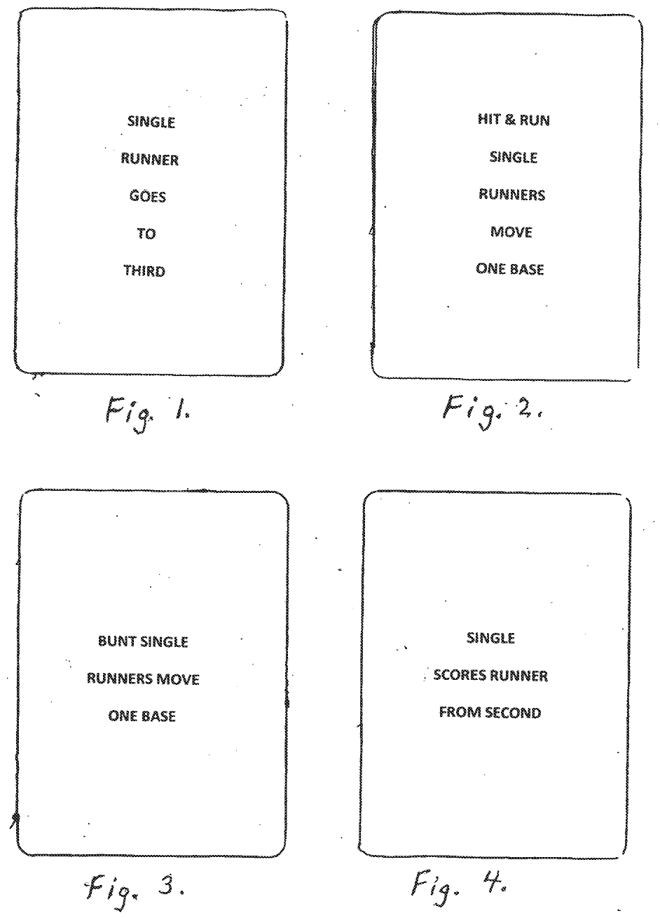

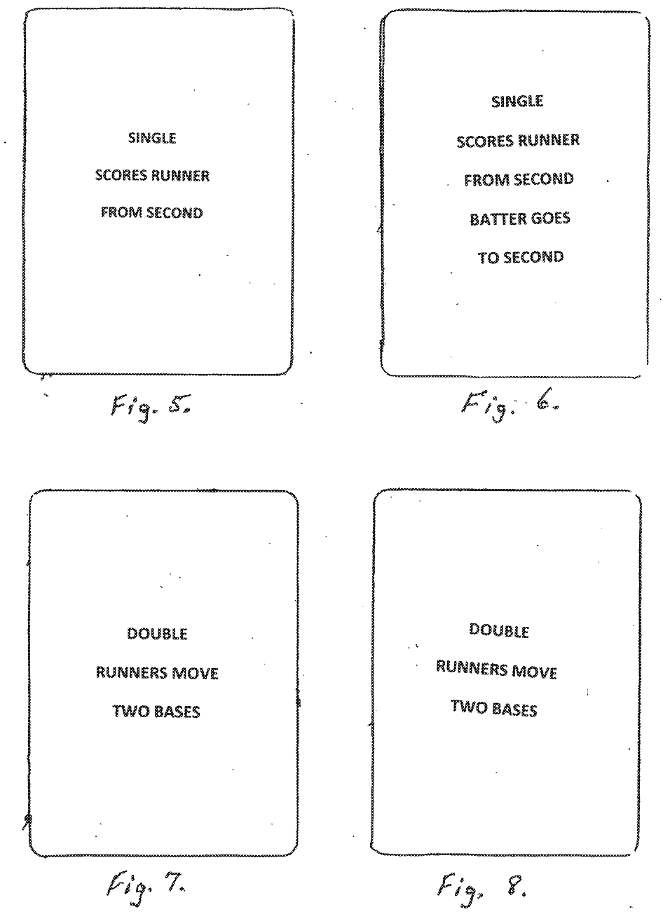

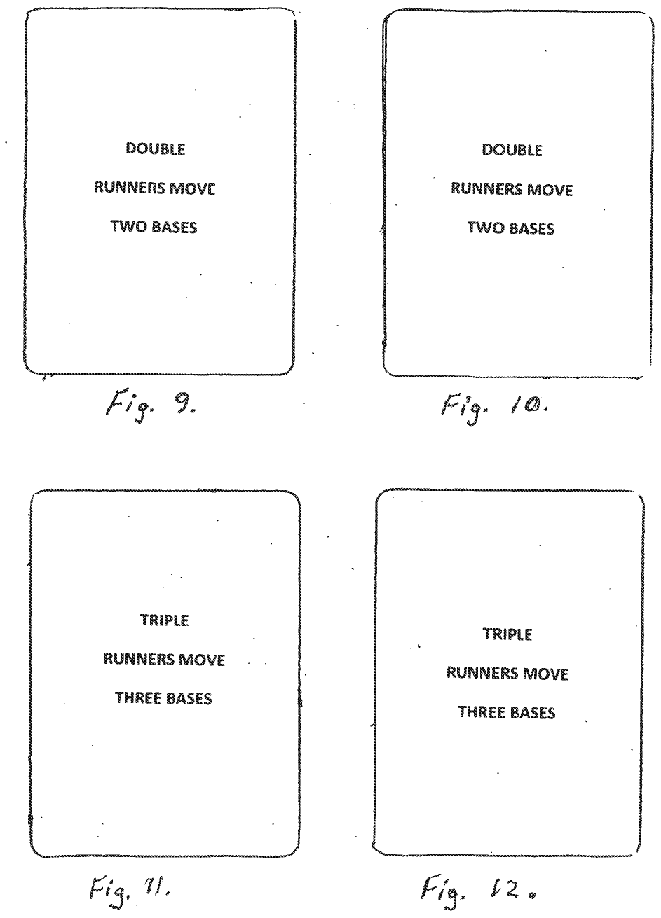

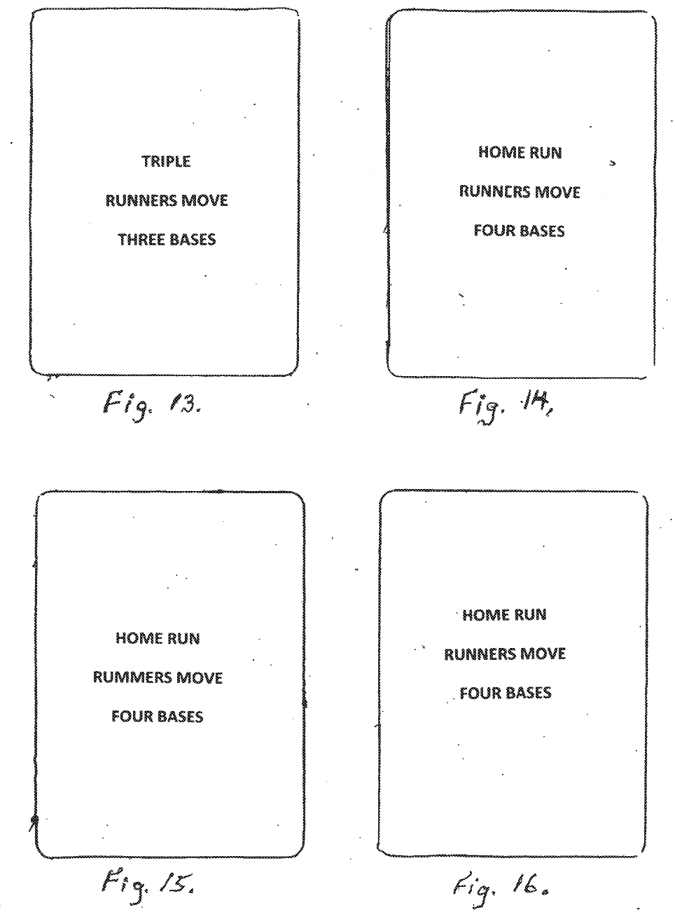

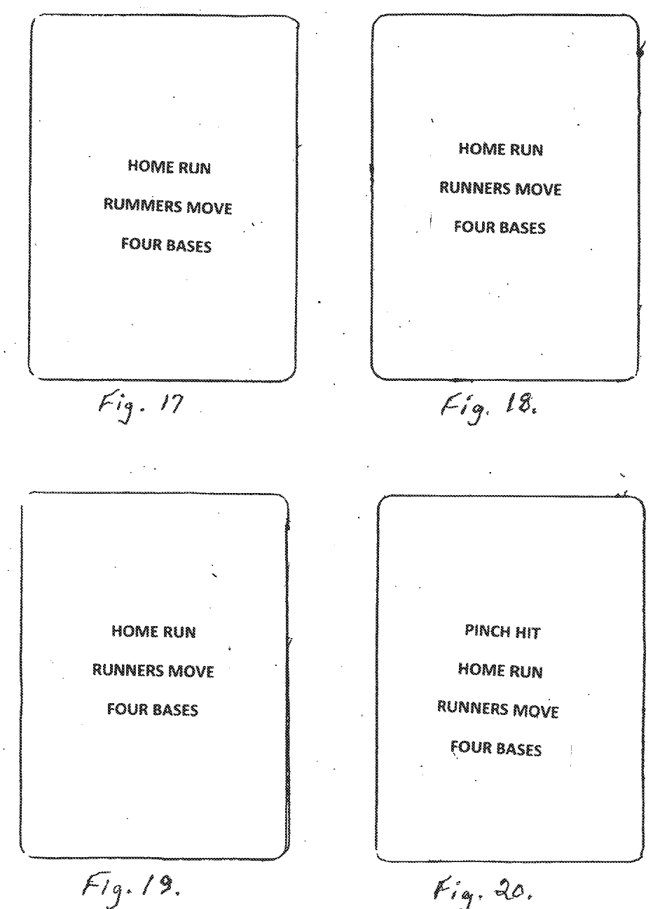

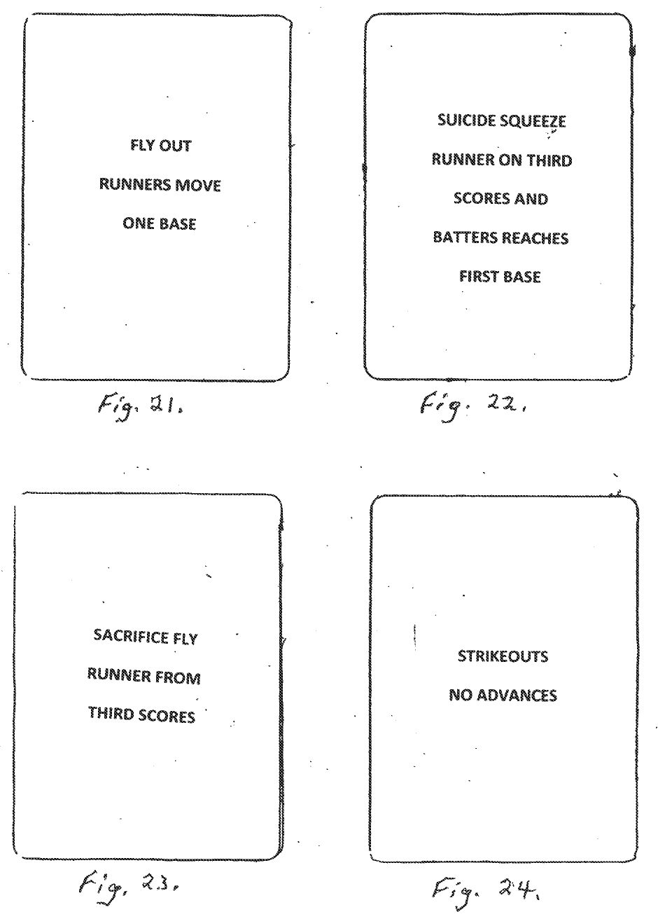

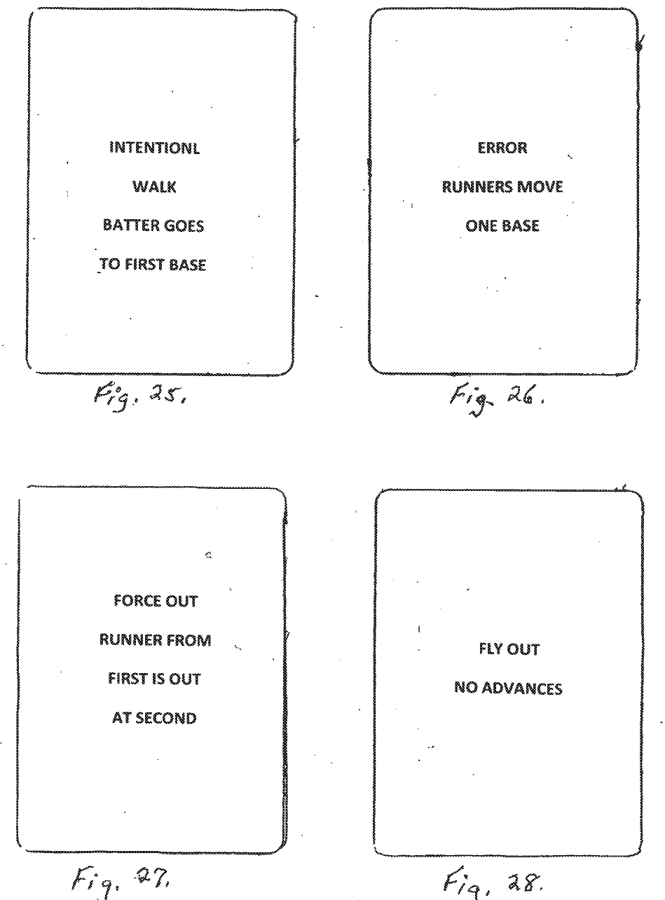

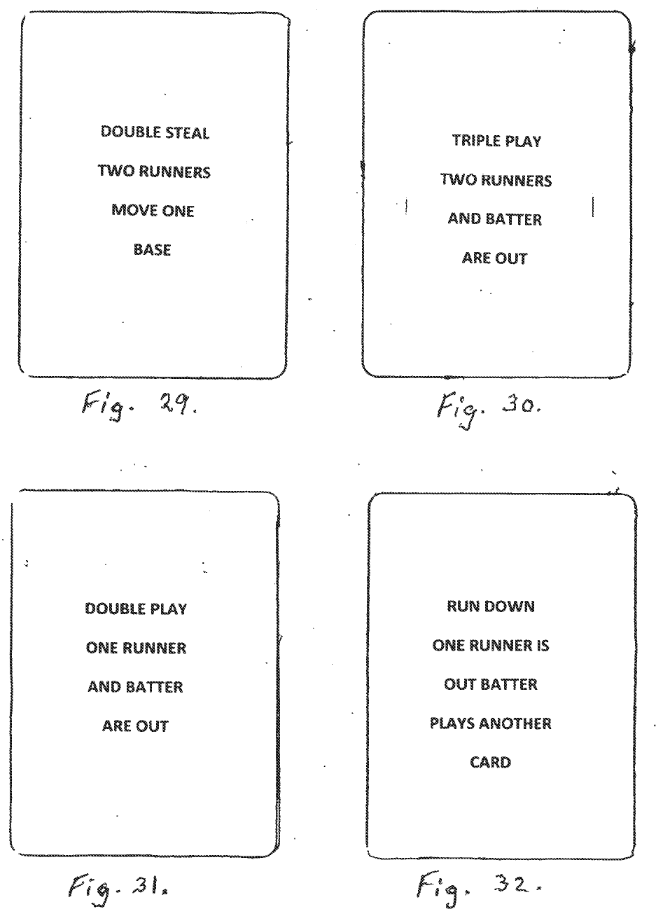

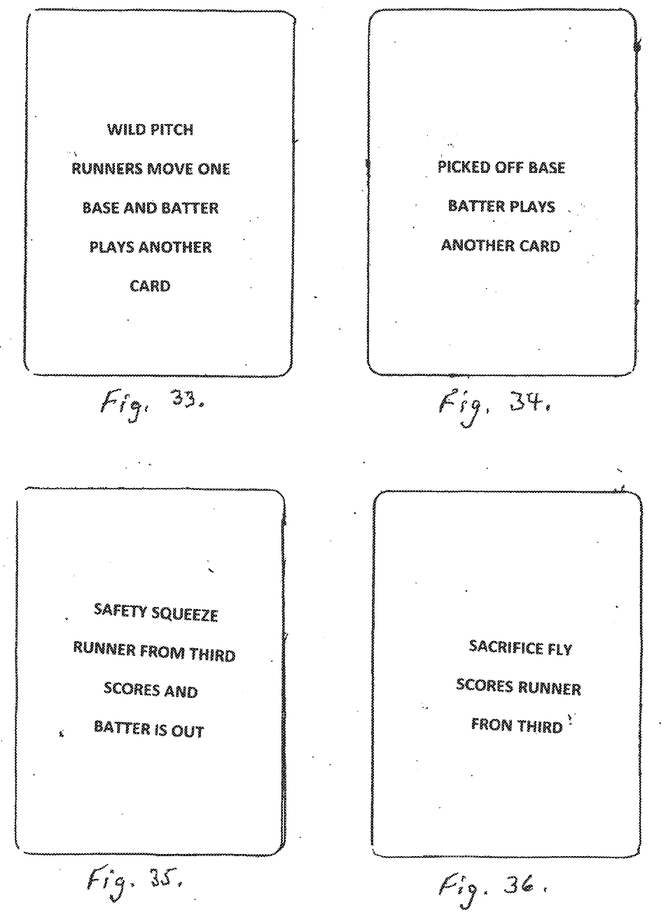

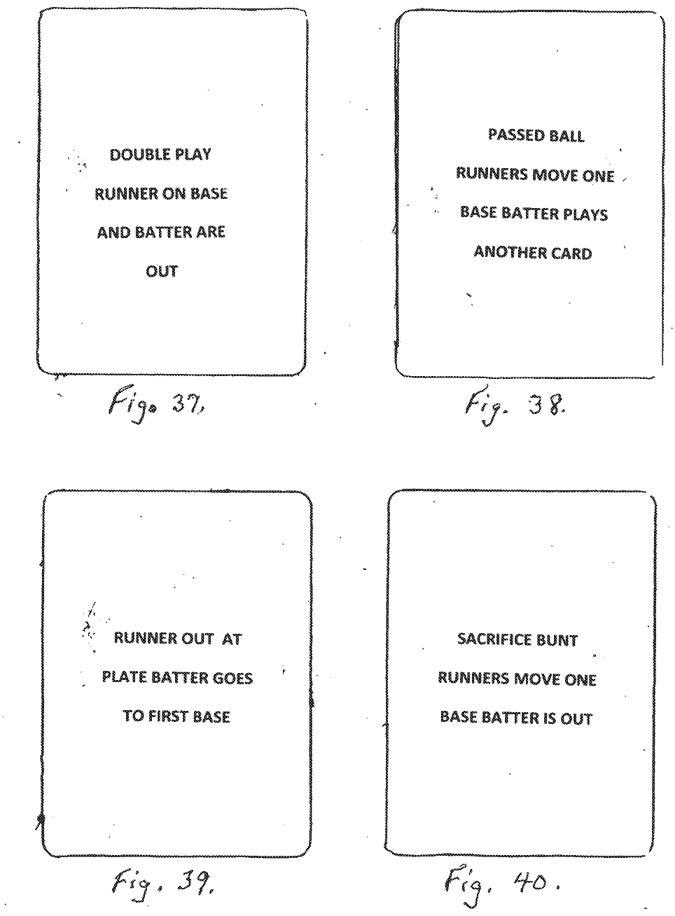

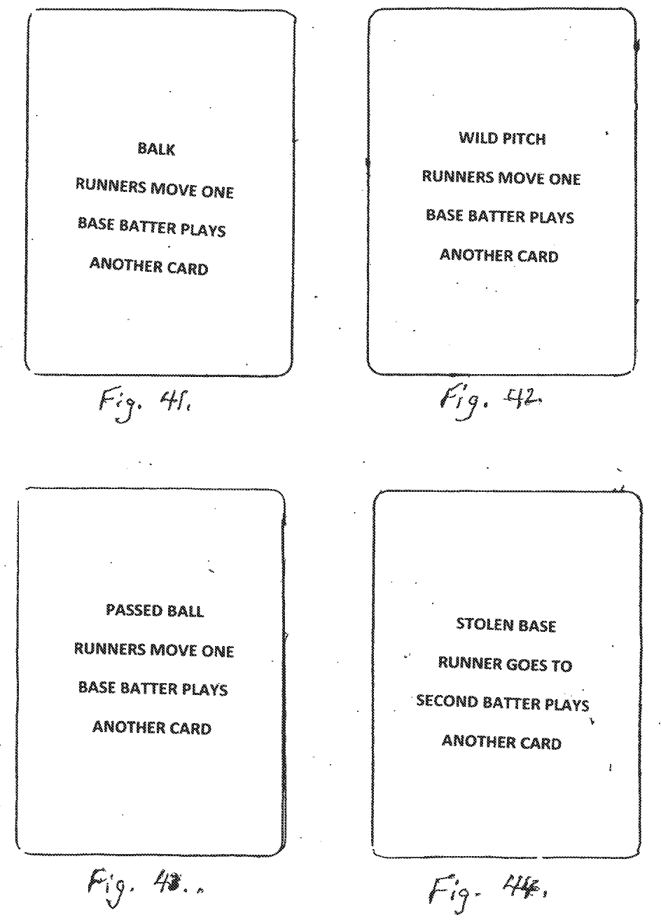

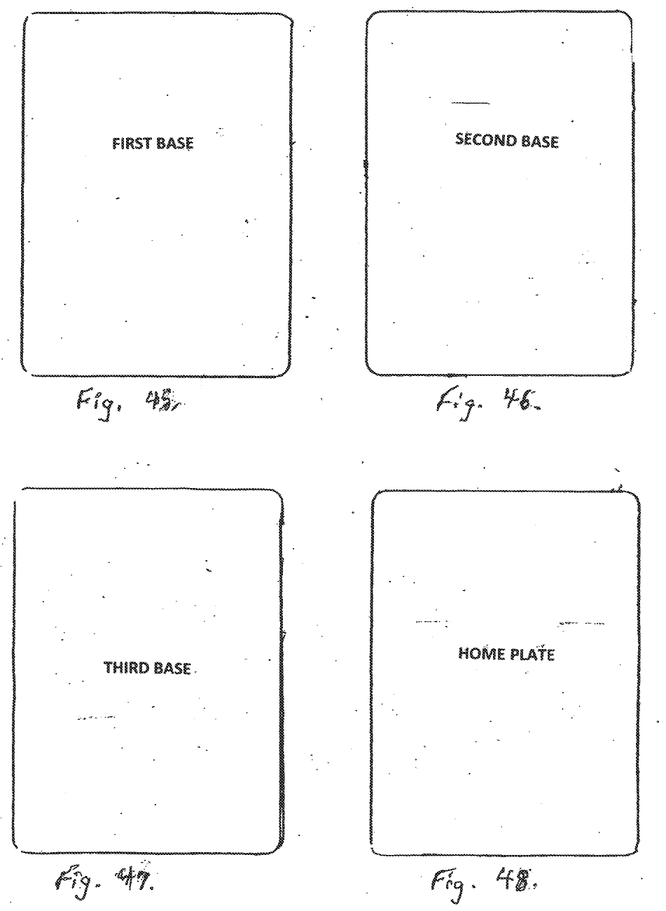

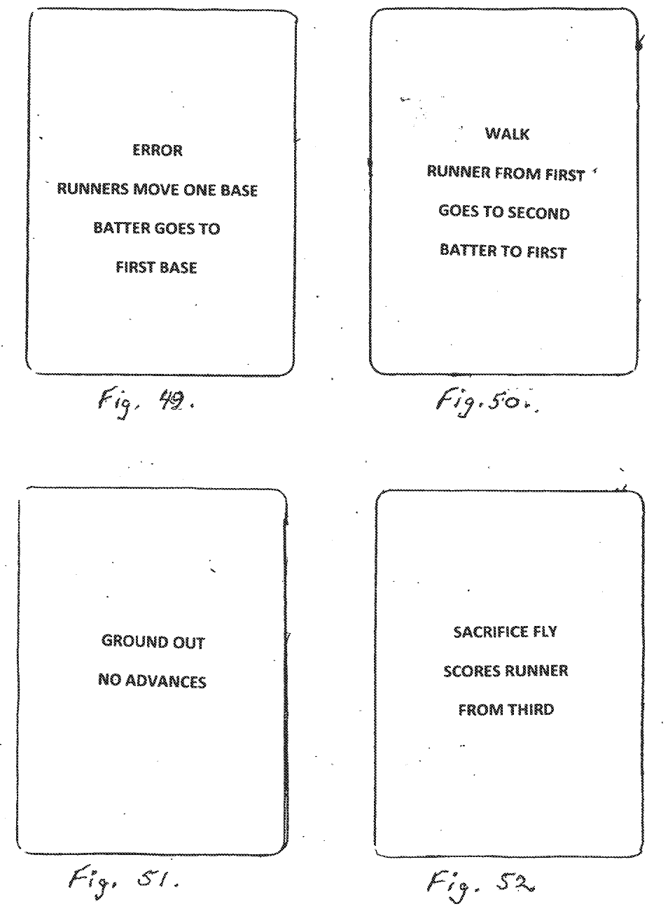

It is to be understood that like reference numerals refer to like parts throughout the several views of the drawings.

### DETAILED DESCRIPTION OF THE INVENTION

Mr. Manager is an educational baseball card game that provides an opportunity for parents to teach their children how to play baseball and for adults who think they can manage a baseball team.

The game is played with a deck of cards that have 52 cards, which have 52 different things that can happen while a batter is at the plate such as a single, double, triple, home run, strikeout, double play, triple play, etc. Some cards will score runs while others will prevent runs from scoring. The object of the game is to score runs while preventing your opponent to score runs. (Please see drawings)

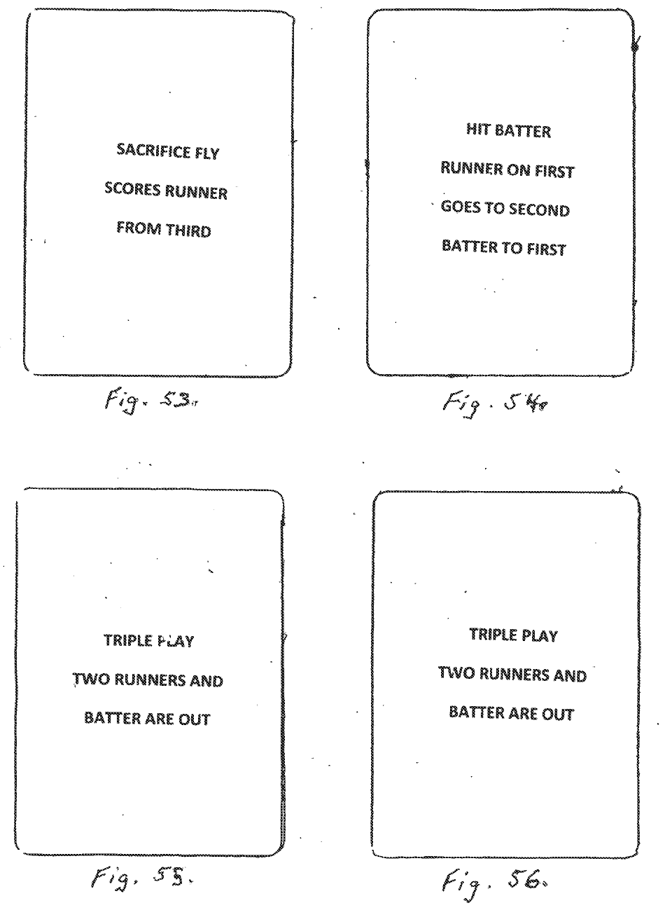

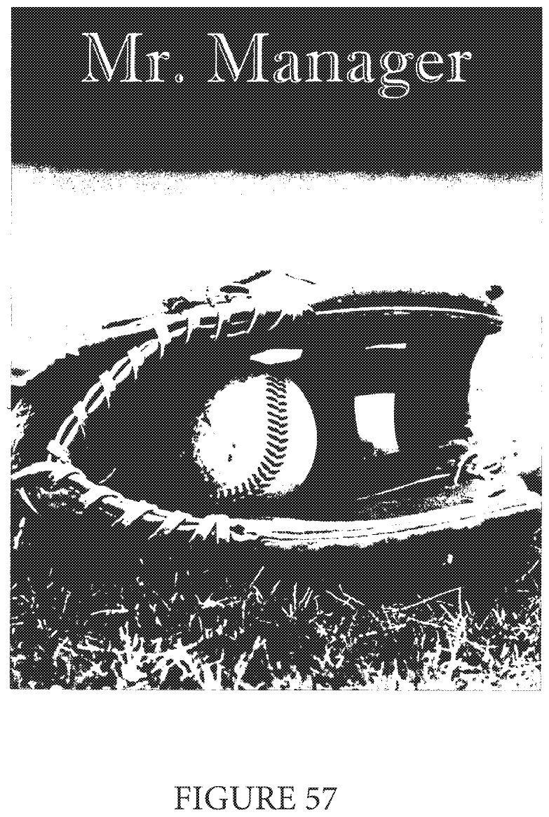

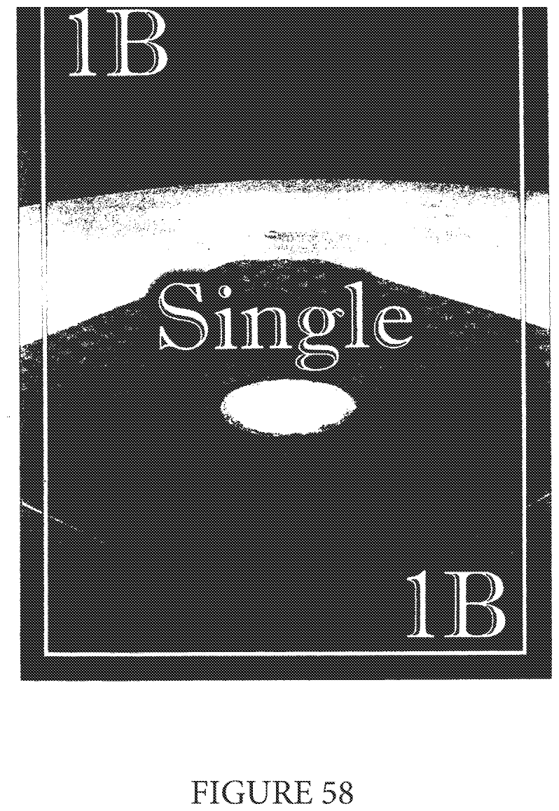

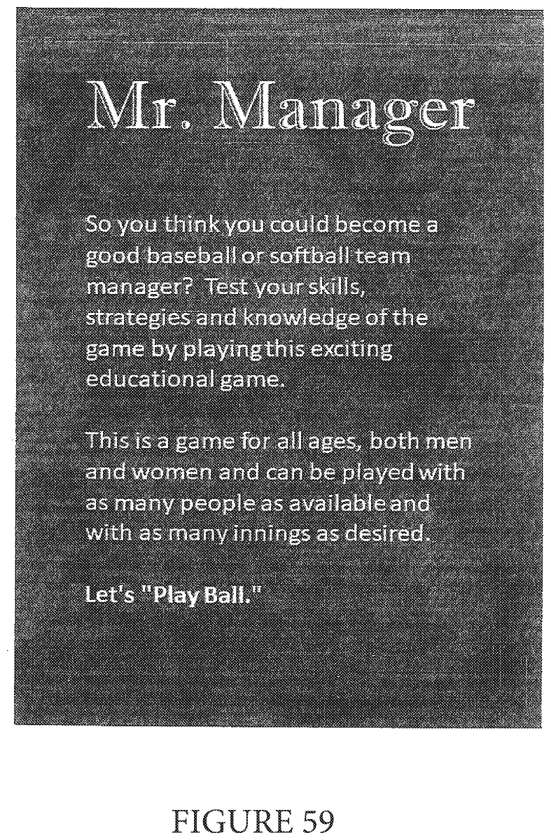

FIGS. 45-48 are first base, second base, third base and home plate. The game is started by placing them on the table in the shape of a baseball diamond. The game can be played with 7 variations. You may use one way for an entire game or a different variation for each inning. The game may be played with two to ten players and as many innings as desired.

Game one is played by dealing an equal number of cards to each player until the deck is completely delt out. Because of a different number of players, there may be a few cards left over which should be placed face down on where the pitcher's mound would be. The player to the left of the dealer starts first. He must play one card. There is a lot of strategy involved. If he has a home run card, he may play it and score one run for himself or he may want to save it for when runners are on base. He may also want to play a card which does not put a runner on base which would be an advantage for the next player to play. If he plays a card which does not put a runner on base he places that card face down on where the pitchers mound would be. When cards are played that put a runner on base that card should be placed on the base that applies to it. This continues until all the cards in each player's hands are played. When players score runs, they place those cards face down in front of them. When all cards are played the inning is over and each player counts their runs. The player to the left of the dealer becomes the next dealer and this rotation continues until the game ends. One player should keep score.

Game two is played by dealing an equal number of cards to each player. The player to the left of the dealer starts first. He places a card that does not put a runner on base face down where the pitcher's mound would be and one card that puts a runner on base. If he has no card that puts a runner on base he may play a second card and put it on the pitcher's mound. Players should always play cards that help them the most and hurts them the least. When all cards are played the inning is over and everyone counts their runs.

Game three starts which each player picking five cards from the deck. He plays one to his advantage and play continues until players have no more cards. They then pick five more cards from the deck and continue playing until the entire deck is used. Because of the different number of players in a game, there may be a few cards left over which should be put face down on the pitcher's mound. If there are not enough cards for each player to take 5 cards then they take 4 cards each or 3 card each, etc. When that ends the inning is over. Count your runs.

Game four is played by using a coach. This could be a parent who is using this game to teach children how to play baseball. He may be used to coach in any of the different games played. He stands behind each player and watches the moves they make. If he sees a good play being made he says, “Nice move,” and when he sees a bad play made he shouts, “foul ball” and explains what the player should have done. This is a great way of teaching little leaguers the strategy of the game.

In game five the dealer gives each player 5 cards. The player to his left starts first and plays all 5 of his cards at the same time. He tries to score as many runs as he can then plays cards that do not put runners on base so as to not help the next player. Some times he is forced to put men on base. The dealer then gives 5 cards to the next player who does the same. Depending on the number of players in the game, the dealer gives equal number of cards to each player until the entire deck is used which ends the inning. Count your runs.

In game six each player selects 3 cards from the deck. If he has a card that does not put a man on base he plays it face down on the pitcher's mound. If he is forced to play a card that puts a man on base he uses the card which helps him the most or hurts him the least. When every players uses up their 3 cards they take 3 more and continue until the deck is used up. As the rounds keep going, make sure there are enough cards so that players have an equal amount. Count your runs.

In game seven all players are given an equal number of cards until the entire deck is used. He must play two cards at a time. This continues until no cards are left and the inning is over. Count your runs.

1. (canceled)

2. (canceled)

3. (canceled)

4. (canceled)

5. An educational baseball card game kit comprising a deck of 52 cards and game instructions.

6. An educational baseball card game played by at least one player with a card game kit comprising 52 cards and game instructions, wherein the 52 cards comprise at least one of the following cards and combinations thereof:
a) a “first base” card;
b) a “second base” card;
c) a “third base” card;
d) a “home plate” card;
e) a “single moving a runner from first to third only” card;
f) a “hit and run single which advances all runners two bases” card;
g) a “bunt single which advances all runners one base” card;
h) a “single which scores a runner from second base” card;
i) a “single which scores a runner from second with batter going to second” card;
j) a “double which advances all runners two bases” card;
k) a “triple which advances all runners three bases” card;
l) a “home run which advances all runners four bases” card;
m) a “pinch hit home run which advances all runners four bases” card;
n) a “fly out which advance all runners one base” card;
o) a “suicide squeeze which scores a runner from third batter reaches first base” card;
p) a “sacrifice fly which scores a runner from third base” card;
q) a “strikeout: no runners advance” card;
r) an “intentional walk which places a runner on first base” card;
s) an “error which advances all runners one base” card;
t) a “force out runner on first is out at second base” card;
u) a “fly out with no runners advancing” card;
v) a “double steal, two runners advance, batter plays another card” card;
w) a “triple play; two runners and batter are out” card;
x) a “double play; two runners are out or a runner and batter are out” card;
y) a “runner out in a run down, batter plays another card” card;
z) a “wild pitch, all runners advance one base, batter plays another card” card;
aa) a “runner picked off any base: batter plays another card” card;
bb) a “safety squeeze with runner scoring and batter out” card;
dd) a “double play with runner on first and batter out” card;
ee) a “passed ball all runners advance one base; batter plays another card” card;
ff) a “runner out at the plate batter reaches first base” card;
gg) a “sacrifice bunt all runners advance one base batter is out” card;
hh) a “balk; all runners advance one base batter plays another card” card;
ii) a “stolen base runner on first goes to second and batter plays another” card;
jj) a “walk; batter goes to first and runners advance if forced” card;
kk) a “ground out with no advances” card; and
ll) a “hit batter; runners advance if forced” card.

7. An educational baseball card game as in claim 6 wherein the game includes a method comprising the following step:
laying out on a playing table a first base card, a second base card, a third base card and a home plate card in the shape of a baseball diamond.

8. An educational baseball game card as in claim 7 wherein the at least one player comprises a plurality of players and a dealer, and the game further comprises the following additional steps:
the dealer dealing from the deck of cards, deals an equal number of cards to each player of the plurality of players, and places any remaining cards face down into a used card area or discard pile where a pitcher's mound would be, the used card area for use to place played cards which do not score runs or put runners on base;
the plurality of players playing a predetermined number of innings, which comprises at least one inning, wherein playing an inning comprises playing a first round and playing a second round, wherein:
playing a first round comprises:
a first player must play at least one card, selecting and playing a “single” card for placing a runner on first base and then placing the played card at the first base; selecting and playing a “double” card or a “triple” card to advance a runner on base and then placing the played card at the base card to which the runner is advanced, or selecting and playing a “home run” card to be last as it scores all runners, the first player playing until the first player has used all of the first player's cards and can no longer put a runner on base, which concludes the first player's turn;
repeating of this process step by each of said plurality of players; and
when runs are scored, the cards are placed face down in front of each player; and
playing a second round comprises:
permitting the plurality of players to play only one card at a time, wherein the players must play only a card that is applicable, and when no player is able to make a move, an inning is over, all players count their runs and keep score of runs with a player keeping score.

9. An educational baseball game card as in claim 7 wherein the at least one player comprises a plurality of players and a dealer, and the game further comprises the following additional steps:
the dealer dealing from the deck of cards, deals an equal number of cards to each player of the plurality of players, and places any remaining cards face down into a used card area where a pitcher's mound would be, the used card area for use to place played cards which do not score runs or put runners on base;
each player of the plurality of players takes a turn wherein a player must select a card that does not result in placing a runner on base, and then place that card face down on the used card area; and then if the player has a card which places a runner on base, the player may select and play the card which places a runner on base, by selecting a “single” card for placing a runner on first base and then placing the played card at the first base; or selecting a “double” card or a “triple” card to advance a runner on base and then placing the played card at the base card to which the runner is advanced, or selecting and playing a “home run” card to be last as it scores all runners, or if the player does not have a card which places a runner on base the player may select a second card that does not result in placing a runner on base place that card on the used card area, concluding the player's turn;
when all cards are played the plurality of players count their runs.

10. An educational baseball game card as in claim 7 wherein the at least one player comprises a plurality of players and a dealer, and the game comprises the following additional steps:
the dealer dealing from the deck of cards, deals five cards to each player of the plurality of players;
the plurality of players each take turns, using the dealt cards to score as many runs as possible, and must play all cards that put runners on base, and each turn concluding when no more moves are possible;
the dealer then deals out five more cards to each player and the game continues;
the dealer then deals out one or two cards to each player, each player receiving the same number of cards, and the dealer then places any remaining cards face down into a used card area where a pitcher's mound would be;
the plurality of players then continue the game, and the players use their defensive cards to take men off the bases to prevent their opponents from scoring; and
after all players complete a turn, the runs are counted.

11. An educational baseball game card as in claim 7 wherein the at least one player comprises a plurality of players and a dealer, and the game comprises the following additional steps:
the dealer dealing from the deck of cards, an equal number of cards to each player of the plurality of players, and placing any remaining cards face down into a used card area where a pitcher's mound would be, the used card area for use to place cards which do not score runs or put men on base;
an umpire or coach looks over the shoulders of the plurality of players as they are making their moves and congratulates them when making a good move or showing them why the move they made was not so good and what move would have been better; and
the dealer decides how many cards each player gets and how many cards may be used at a time; and
after play, when all players “pass” the inning is over and runs are counted.

12. An educational baseball game card as in claim 7 wherein the at least one player comprises a plurality of players, and the game comprises the following additional steps:
each player of the plurality of players may take a predetermined number of cards and may use the cards to score as many runs as possible, and if a player leaves a runner on base and has a card that would take that runner off the base, the player may play the card so that an opponent cannot score;
each player is not required to play all the cards, but may use only the cards that are to that player's advantage;
when a player completes a turn, another player may take a turn; and
any leftover cards may be placed face down on the pitcher's mound;
when all players have taken a turn, runs are counted.

13. An educational baseball game card as in claim 7 wherein the at least one player comprises a plurality of players and the game comprises the following additional steps:
each player of said plurality of players takes one card from the deck and turns it over, and the player who has the best offensive card becomes a starting player, who starts the game by taking two more cards from the deck;
each player then takes two more cards from the deck so each player now has three cards;
the plurality of players each take a turn, use the 3 cards to their best advantage, and must play at least one card;
in a next round, each player takes 3 more cards and plays the cards to their best advantage, and must play at least one card;
in a next round, the cards remaining in the deck must be counted so each player receives the same number of cards, and any leftover cards are placed on the pitcher's mound face down; and
after all players conclude their turns runs are counted.

14. An educational baseball game card as in claim 7 wherein the at least one player comprises a plurality of players and a dealer, and the game comprises the following additional steps:
the dealer dealing the entire deck of cards, deals an equal number of cards to each player with any leftover cards placed face down on the used card area;
each player takes a turn playing two cards per turn, until each player has no cards to play; and
each player's runs are counted.
